(19) United States
(12) Patent Application Publication
(10) Pub. No.: US 2004/0051038 A1
(43) Pub. Date: Mar. 18, 2004

(54) Ion guide

(75) Inventor: Junichi Taniguchi, Kyoto-shi (JP)

Correspondence Address: KANESAKA AND TAKEUCHI, 1423 Powhatan Street, Alexandria, VA, 22314, US

(73) Assignee: SHIMADZU CORPORATION

(21) Appl. No.: 10/630,733

(22) Filed: Jul. 31, 2003

(30) Foreign Application Priority Data
Sep. 17, 2002 (JP) 2002-270320

(51) Int. Cl. H01J 49/06

(52) U.S. Cl. 250/288

(57) ABSTRACT

An ion guide is installed in an intermediate chamber provided between a low vacuum chamber and a high vacuum chamber, and is located on a passage of transporting ions from the low vacuum chamber to the high vacuum chamber. The ion guide includes a plurality of plate-shape electrodes juxtaposed in a transport direction of the ions in the intermediate chamber and provided with ion passage holes around an ion beam axis, respectively; a plate-shape aperture electrode disposed as a part of partition for separating the intermediate chamber and an adjacent chamber and provided with an aperture around the ion beam axis; and high frequency power sources for applying high frequency electric voltages to the plate-shape electrodes and the aperture electrode, respectively.

### BACKGROUND OF THE INVENTION AND RELATED ART STATEMENT

The invention relates to an ion guide for guiding ions produced at a low vacuum area to a high vacuum area.

A liquid chromatograph mass spectrometer and the like uses an electro-spray mass spectrometer, high frequency inductive coupling plasma mass spectrometer, atmospheric pressure chemical ionization mass spectrometer and the like as a mass spectrometry portion thereof. In these devices, a sample is ionized, and a quadrupole mass spectrometer or a time-of-flight mass spectrometer analyzes the ions for the mass spectrometry.

While the sample is ionized under a pressure near the atmospheric pressure, the mass spectrometry is required to be carried out under a high vacuum to suppress scattering of the ions. Therefore, it is necessary to transport the ions from a ion source in a low vacuum area to a mass spectrometer in a high vacuum area. It is important to suppress loss of the ions caused during the transportation thereof for attaining a high sensitivity of the mass spectrometer.

Hereunder, with reference to FIG. 1, a structure for transporting the ions from a low vacuum area to a high vacuum area will be explained by means of an electro-spray mass spectrometer as an example.

The mass spectrometer includes the first intermediate chamber 12 and the second intermediate chamber 13 between an ionizing chamber 11 provided with a nozzle 15 connected to an exit of a column of a liquid chromatograph device and a mass spectrometry chamber 14 provided with a quadrupole filter 17 and an ion detector 18. The ionizing chamber 11 and the first intermediate chamber 12 are isolated by a partition provided with a desolvent pipe 16 having a small diameter. Between the first intermediate chamber 12 and the second intermediate chamber 13 and between the second intermediate chamber 13 and the mass spectrometry chamber 14 are provided partitions having apertures 19, 20 with a small diameter, respectively. The first intermediate chamber 12 and the second intermediate chamber 13 include ion guides 21 and 22, respectively.

The ionizing chamber 11 is held in a substantially atmospheric pressure for spraying a sample liquid through the nozzle 15. The first intermediate chamber 12 is exhausted to be a low vacuum area in the order of 10⁺² Pa through a rotary pump, and the second intermediate chamber 13 is exhausted to be a middle vacuum area in the order of 10⁻¹-10⁻² Pa through a turbo molecular pump. The mass spectrometry chamber 14 is exhausted to be a high vacuum area in the order of 10⁻⁴ Pa through a turbo molecular pump. In other words, the mass spectrometry chamber 14 is held under a high vacuum condition by gradually increasing the vacuum levels from the ionizing chamber 11 toward the mass spectrometry chamber 14 (differential exhaustion).

Incidentally, the shown example includes two intermediate chambers. Alternatively, the number of the intermediate chambers may be two or more, or in order to simplify the device, the intermediate chamber may be one.

The sample liquid is sprayed in the ionizing chamber 11 through the nozzle 15, and sample molecules are ionized while a solvent in liquid drops is evaporated. The fine liquid drops containing ions are drawn into the desolvent pipe 16 by the pressure difference between the ionizing chamber 11 and the first intermediate chamber 12. The solvent is further evaporated while passing through the desolvent pipe 16 to thereby promote the ionization. The sample is ionized as described above, and the ions reach the mass spectrometry chamber 14 through the ion guide 21, aperture 19, ion guide 22 and aperture 20.

Conventionally, an electrostatic ion lens as shown in FIG. 2 has been used to transport the ions in the intermediate chamber. Different DC voltages are applied to the juxtaposed plural electrostatic ion lenses 23 to transport the ions with potential difference between the respective electrostatic ion lenses. However, with such an ion lens, when the ions change an advancing direction through collision with air molecules in the low vacuum area, it is impossible to return the ions to the original advancing direction, resulting in poor ion transport efficiency.

Recently, an ion guide using a high-frequency electric field has been used. As shown in FIG. 3 and FIG. 4, such ion guides include a multipole ion guide wherein an even number of pole electrodes 24 is disposed in parallel and symmetrical relative to an ion beam axis; and an ion guide wherein a plurality of ring-shape poles 25 is disposed in the advancing direction. In any of these ion guides, high frequency voltages having different phases are applied to the adjacent electrodes to form a high frequency electric field. Even if the advancing direction of the ions is changed by collision with the gas molecules in the low vacuum area, the ions are reflected toward the central (ion beam axis) direction in the ion guide by the high frequency electric field to thereby proceed to the heading direction. Therefore, the transport efficiency of the ions in the ion guide is higher than that of the conventional electrostatic ion lens where the DC voltage is applied.

It is preferable that the ion guide has a large inner diameter in order to increase a quantity of the transported ions, while it is preferable that the aperture has a small inner diameter in order to maintain the vacuum levels in the respective chambers. Therefore, the ions passing through the ion guide tend to collide against a partition around the aperture, resulting in lower ion transport efficiency.

As shown in FIG. 5, in order to increase the number of the ions passing through the ion guide and the aperture as much as possible, there have been used a method wherein an electrostatic ion lens 26 is disposed between the ion guide and the aperture; and a method wherein an aperture itself has an electrostatic lens function. However, in any of these methods, a high frequency electric field is not created between the ion guide and the aperture (area 27 in an example shown in FIG. 5). Accordingly, it is possible that the ions collide against the gas molecules in the low vacuum atmosphere to thereby change their advancing direction.

As described above, although the ion transport efficiency of the mass spectrometer as a whole has been improved, the ion transport efficiency in the vicinity of the aperture has not been improved yet.

In view of the above problems, the present invention has been made, and an object of the invention is to provide an ion guide with improved ion transport efficiency in the vicinity of the aperture, thereby obtaining the high ion transport efficiency of the device as a whole.

Further objects and advantages of the invention will be apparent from the following description of the invention.

### SUMMARY OF THE INVENTION

In order to solve the above problems, according to the present invention, an ion guide is installed in an intermediate chamber provided between a low vacuum chamber and a high vacuum chamber, and is located on a passage of transporting ions from the low vacuum chamber to the high vacuum chamber. The ion guide includes a plurality of plate-shape electrodes juxtaposed in a transport direction of the ions in the intermediate chamber and provided with ion passage holes around an ion beam axis, respectively; a plate-shape aperture electrode disposed as a part of partition for separating the intermediate chamber and an adjacent chamber and provided with an aperture around the ion beam axis; and high frequency power sources for applying high frequency electric voltages to the plate-shape electrodes and the aperture electrode, respectively.

### BRIEF DESCRIPTION OF THE DRAWINGS

FIG. 1 is a block diagram showing a structure of a mass spectrometer;

FIG. 2 is a sectional view showing a structure of an electrostatic ion lens;

FIG. 3 is a perspective view showing an ion guide with a conventional multipole structure;

FIG. 4 is a perspective view showing a structure of an ion guide using conventional ring-shape electrodes;

FIG. 5 is a drawing showing an area of ion dispersion in a conventional ion guide;

FIGS. 6(a) and 6(b) are sectional views showing structures of ion guides according to the present invention;

FIG. 7 is a sectional view showing a structure where DC voltages are applied to the respective electrodes in the ion guide according to the present invention; and

FIG. 8 is a sectional view showing an embodiment of a mass spectrometer using the ion guide according to the present invention.

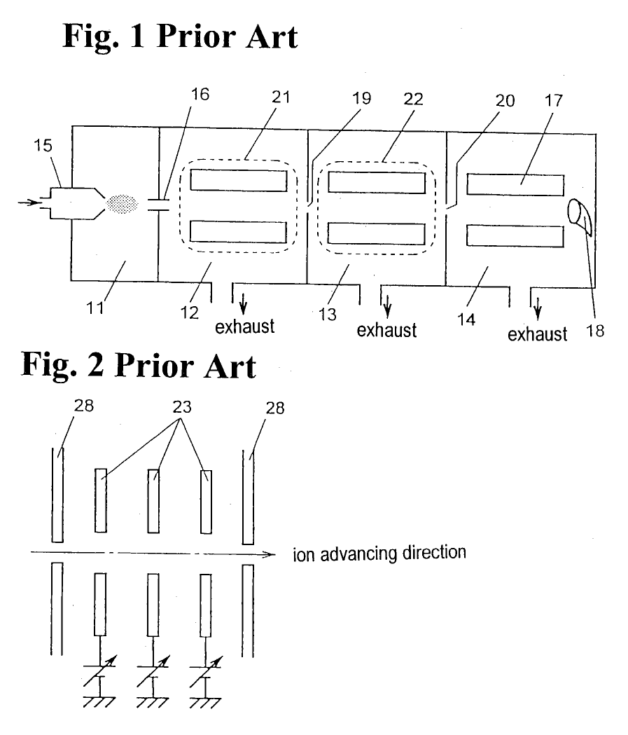

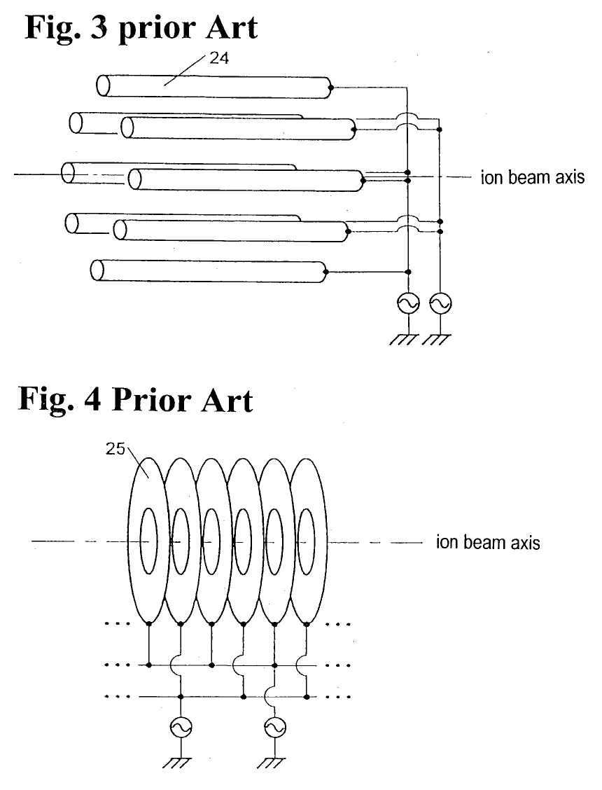

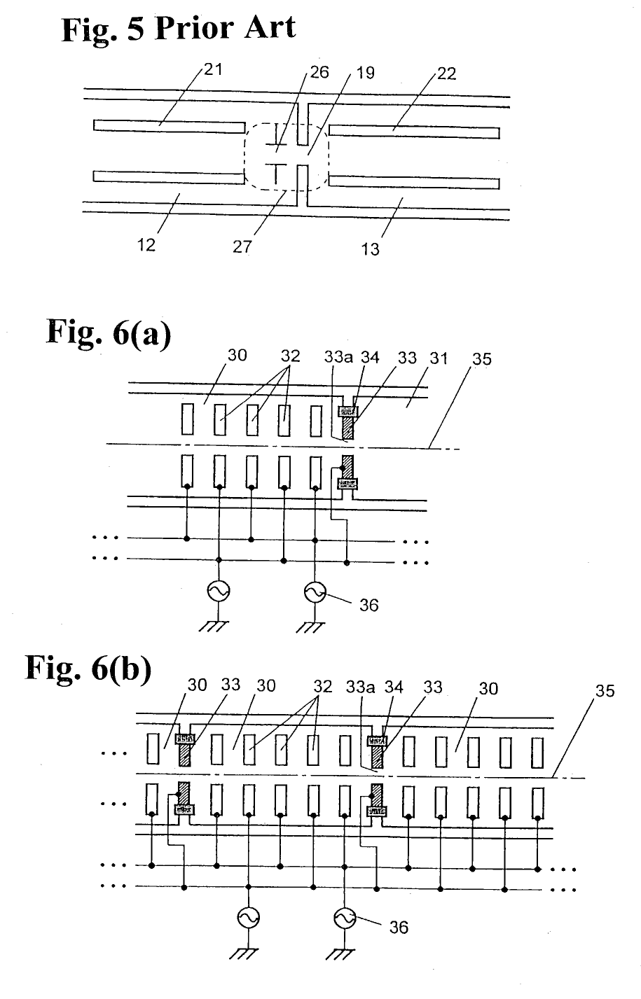

### DETAILED DESCRIPTION OF PREFERRED EMBODIMENT

The invention is applicable to a device including one or more intermediate chambers held at an intermediate vacuum level between a low vacuum chamber, such as an ionizing chamber, and a high vacuum chamber, such as a mass spectrometry chamber.

According to the present invention, an ion guide is provided in the intermediate chamber. The intermediate chamber is isolated from both adjacent chambers by partitions. In the present specification, the “adjacent chamber” includes another intermediate chamber, low vacuum chamber, or high vacuum chamber. Also, while one intermediate chamber includes two adjacent chambers, the following explanation will focus on only one of the two adjacent chambers for explanation purpose. The structure described below is applicable to other adjacent chambers.

Hereunder, with reference to FIG. 6(a), the ion guide of the invention will be described. A plurality of plate electrodes 32 having holes through which ions pass is juxtaposed around an ion beam axis in the ion transport direction in an intermediate chamber 30.

A plate electrode (aperture electrode 33) having an aperture 33a around the ion beam axis is provided on a partition between an intermediate chamber 30 with the plate electrodes 32 and an adjacent chamber 31. In a case that the partition is made of a conductive material, an insulating member 34 is provided between the partition and the aperture electrode 33. The aperture 33a maintains a difference in vacuum levels between an intermediate chamber 30 and the adjacent chamber 31 while transporting the ions from the intermediate chamber to the adjacent chamber (or introducing the ion from the adjacent chamber 31 to the intermediate chamber 30).

As described above, it is preferable that the plate electrode 32 has a large ion transport hole in order to increase the quantity of the ions, while it is preferable that the aperture electrode 33 has a small aperture in order to hold the difference in the vacuum levels between the intermediate chamber 30 and the adjacent chamber 31.

A high-frequency (HF) power source 36 is connected to these plate electrodes 32 and aperture electrode 33. In the embodiment shown in FIG. 6(a), two HF power sources are used and the adjacent electrodes are connected to different HF power sources. HF voltages having different phases by 180° are applied to the electrodes from the two HF power sources, respectively. The HF power sources are connected to both the plate electrodes 32 and the aperture electrode 33 in the same way. Therefore, a consistent continuous HF electric field is formed around the ion beam axis, so that the plate electrodes 32 and the aperture electrode 33 function as an ion guide in collaboration.

The ions passing through the ion guide are drawn back to the periphery of the ion beam axis 35 by the HF electric field when the ions collide with the gas molecules in the intermediate chamber. The HF electric field is formed up to the aperture electrode 33 disposed at the boundary of the adjacent chamber, so that a large number of the ions can reach the adjacent chamber.

In the embodiment described above, the description is focused only on one intermediate chamber. As shown in FIG. 6(b), in a case that plural intermediate chambers are continuously provided, a plurality of plate electrodes 32 is juxtaposed in the respective intermediate chambers, and the aperture electrodes 33 are provided at the boundaries between the respective intermediate chambers. The HF power sources 36 are connected to the plate electrodes 32 and the aperture electrodes 33. With this structure, the consistent continuous HF electric field is formed over the plural intermediate chambers, so that a great number of the ions can reach the adjacent chamber through the plural intermediate chambers.

Further, an electric field gradient may be formed in the travelling direction of the ion by superposing different DC voltages on the HF electric voltages applied to the respective electrodes, so that the ion can be accelerated in the travelling direction. Also, it is possible to control the kinetic energy of the ion by controlling a size of the electric field gradient.

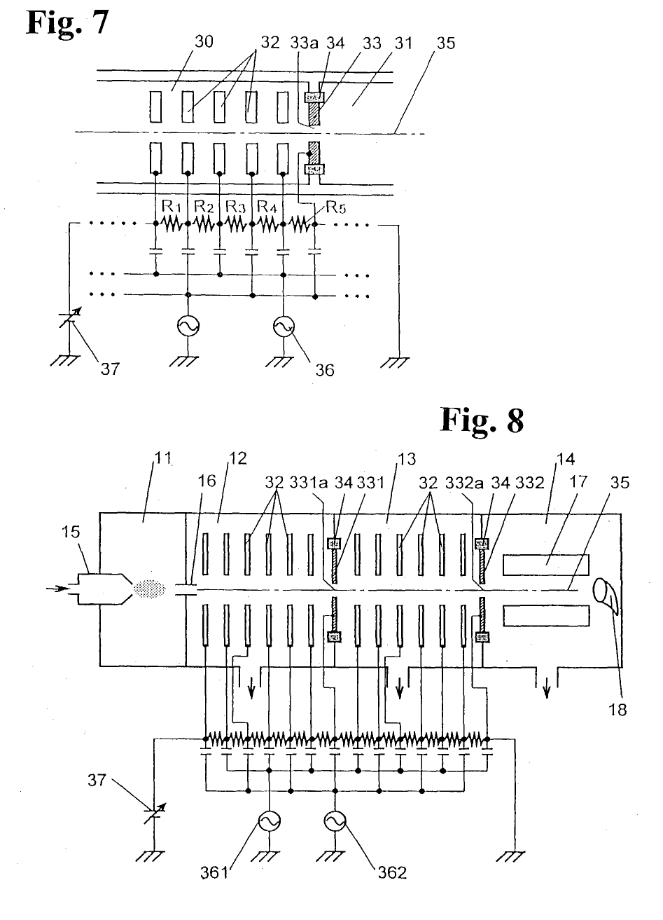

FIG. 7 shows a structure for superposing the DC voltage as described above. Resistances R₁, R₂, . . . are connected between the adjacent electrodes, respectively, and the DC voltage is applied to the resistances from a DC power source 37, so that different DC potentials are applied to the respective plate electrodes 32 and the aperture electrode 33. As a result, different DC voltages are superposed on the HF voltages applied to the respective electrodes. It is possible to control the size of the DC voltage applied to the respective electrodes by controlling the DC voltages applied from the DC power source 37.

According to the ion guide of the invention, the consistent continuous HF electric field can be formed around the aperture by structuring the aperture itself as one of the electrodes constituting the ion guide. Therefore, a large number of the ions can pass through the aperture since the loss of the ion due to collision with the gas molecules is suppressed, thereby obtaining the high ion transport efficiency as a whole device. The ion guide according to the embodiment is applicable to various devices for transporting the ions from the low vacuum area to the high vacuum area. For example, a mass spectrometer using the present ion guide can carry out analysis with a high sensibility due to the high ion transporting efficiency.

As an embodiment of the present invention, a liquid chromatograph mass spectrometer provided with the ion guide according to the present invention will be explained with reference to FIG. 8. In the same manner as in the mass chromatograph spectrometer having a conventional configuration, the liquid chromatograph mass spectrometer includes the first intermediate chamber 12 and the second intermediate chamber 13 between an ionizing chamber 11 for ionizing a liquid sample and a mass spectrometry chamber 14. The respective chambers are separately pumped so that a vacuum level of every chamber is gradually increased from the ionizing chamber 11 toward the mass spectrometry chamber 14. A quadrupole mass spectrometer is provided in the mass spectrometry chamber 14 shown in FIG. 8. Alternatively, other mass spectrometer such as a time-of-flight type mass spectrometer may be provided in the mass spectrometry chamber 14.

The ion guide of the invention is provided in the first intermediate chamber 12 and the second intermediate chamber 13 from right after a desolvent pipe 16. A plurality of the plate electrodes 32 having the ion transit holes with a diameter of 5 mm is provided in the first intermediate chamber 12 and the second intermediate chamber 13, respectively. An aperture electrode 331 is provided between the first intermediate chamber 12 and the second intermediate chamber 13. Also, an aperture electrode 332 is provided between the second intermediate chamber 13 and the mass spectrometry chamber 14. The aperture electrodes 331 and 332 are provided with apertures 331a and 332a having a diameter of 3 mm or 5 mm in order to hold a difference in the vacuum levels between the adjacent chambers on both sides and to allow the ions to pass therethrough.

The high frequency power sources are connected to the plate electrodes 32 and the aperture electrodes 331 and 332. In the present embodiment, two high frequency power sources 361 and 362 are alternately connected to the adjacent electrodes to apply the electric power. The high frequency power sources 361, 362 apply the high frequency voltages having different phases by 180° to the electrodes, respectively. With application of the high frequency voltages, the consistent continuous high frequency electric field is formed from right after the desolvent pipe 16 to the aperture 332a.

Further, in the present embodiment, resistances are connected between the adjacent electrodes, and the DC voltage is applied to the resistances from the DC power source 37 so that the different DC voltages are applied to the respective plate electrodes 32 and aperture electrodes 331, 332 to thereby provide the electric field gradient in the ion travelling direction.

The ions are transported in the mass spectrometer having the structure as described above in a way described below. A sample liquid is atomized in the ionizing chamber 11 and further passed through the desolvent pipe 16 to thereby ionize the sample molecules. The first plate electrode 32 is provided right after the desolvent pipe 16. The ion passage hole of the plate electrode 32 has a diameter (5 mm) larger than the inner diameter (0.3 mm) of the desolvent pipe 16. Therefore, the ions passed through the desolvent pipe 16 are introduced into the ion passage hole of the first plate electrode 32 while only a small quantity of the ions spreads in a vertical direction with respect to the ion beam axis 35. As a result, the loss of the ions between the desolvent pipe 16 and the first plate electrode 32 is sufficiently small.

The consistent continuous high frequency electric field is formed from the ion passage hole of the first plate electrode 32 to the aperture 332a. Thus, the ions are drawn back to the periphery of the ion beam axis 35 even if the ions collide with the gas molecules or the like in the first intermediate chamber 12 and the second intermediate chamber 13 including the vicinities of the apertures where the ions are typically lost, so that a large quantity of the ions can reach the mass spectrometry chamber 14.

Further, the ions are accelerated in the heading direction of the ion beam axis 35 through the electric field gradient formed by superposing the DC voltage on the HF voltage applied to the respective electrodes. It is possible to transport the ions from the ionizing chamber 11 to the mass spectrometry chamber 14 only by using the difference in the vacuum levels of the respective chambers without providing the electric field gradient. However, it is possible to further accelerate the ions in the advancing direction by the electric field gradient. It is also possible to control the kinetic energy of the ions by controlling the size of the electric field gradient.

While the invention has been explained with reference to the specific embodiments of the invention, the explanation is illustrative and the invention is limited only by the appended claims.

What is claimed is:

1. An ion guide for guiding ions in an analytical device having an intermediate chamber, comprising:
a plurality of plate-shape electrodes disposed in the intermediate chamber and juxtaposed in a transport direction of the ions, each of said plate-shape electrodes having an ion passage hole around an ion beam axis;
a plate-shape aperture electrode disposed as a partition between the intermediate chamber and an adjacent chamber, said aperture electrode having an aperture around the ion beam axis; and
a high frequency power source for applying a high frequency electric voltage to the plate-shape electrodes and the aperture electrode so that ions are transported from the intermediate chamber to the adjacent chamber with high efficiency.

2. An ion guide according to claim 1, further comprising a DC power source connected to the plate-shape electrodes and the aperture electrode for applying a DC voltage to accelerate the ions.

3. An ion guide according to claim 2, further comprising resistances connected between the adjacent plate-shape electrodes and the aperture electrode for creating an electric field gradient.

4. An ion guide according to claim 1, wherein said high frequency power source includes a pair of power sources connected to the adjacent plate-shape electrodes and the aperture electrode alternately for applying the high frequency electric voltages having phases shifted by 180 degree with each other.

5. An ion guide according to claim 1, wherein said plate-shape electrodes have the ion passage holes with a diameter larger than that of the aperture electrode.
